(19) United States
(12) Patent Application Publication
(10) Pub. No.: US 2013/0241268 A1
(43) Pub. Date: Sep. 19, 2013

(54) WHEEL COVER TAB STRUCTURE

(71) Applicant: HUNG-SHENG WANG, TAINAN CITY (TW)

(72) Inventor: HUNG-SHENG WANG, TAINAN CITY (TW)

(73) Assignee: GUU YIH PLASTICS CO., LTD., TAINAN CITY (TW)

(21) Appl. No.: 13/423,515

(22) Filed: Mar. 19, 2012

(51) Int. Cl. B60B 7/10

(52) U.S. Cl. 301/37.102

(57) ABSTRACT

An improved wheel cover tab structure is provided in which a plurality of hollow apertures having ornamental design are provided on the wheel cover, and a plurality of snap tab structure for engaging a metal ring are provided at equal interval on the inboard surface of the wheel cover. Each snap tab structure comprises: an base portion integrally formed on the inboard surface of a spoke and having a slot provided thereon; and a snap tab body connected with the base portion, the snap tab body being integrally formed in the space of the hollow aperture and having an engaging foot corresponding to the slot; a notch for placement of the metal ring being formed on the other face opposite to the engaging foot. As the base portion and the snap tab body are fully aligned with each other, the engaging foot can engage within the slot without any deviation.

### BACKGROUND OF INVENTION

1. Field of the Invention

The present invention relates to a wheel cover tab structure which is simple in operation, easy in assembling, and which can reduce bulk volume occupied after stacking of wheel covers so as to lower the cost of storage and transportation.

2. Brief Description of the Prior Art

Ordinarily, conventional wheel cover is provided with ornamental design of aperture holes, painting colors, or patterns on its outboard surface so as to meet the pursuit of fashion or different needs of feeling nowadays. Conventional wheel cover comprises a disk type wheel cover main body the inboard surface of which is integrally provided with a plurality of snap tabs disposed along a periphery; and a metal ring is fitted on the snap tabs. In installing the wheel cover to the wheel, the inboard surface of the wheel cover main body mounts against the outboard surface of the wheel, and simultaneously the snap tabs is deflected outwardly by the tension of the metal ring fitted in the inside of the wheel cover main body, so that the snap tabs can be engaged within the snap edge to fasten the wheel cover to the wheel.

However, as the snap tabs integrally molded around the inboard surface of the wheel cover main body are formed to protrude upwardly, the protruding snap tabs become a limitation in stacking the wheel covers up for packing so that the gap between two wheel covers in the stack is large, and thus the space occupied after stacking cannot be reduced and the cost for storage and transportation is increased.

In view of the above reasons, the inventor of the present invention has proposed a new invention disclosed in Taiwanese New Utility Patent Gazette No. M330209 entitled “Improvement on Wheel Cover Tab Structure”, in which insert blocks are integrally formed around hollow apertures of the wheel cover so as not to affect the bulk volume of wheel cover stack for packing, and further to increase packing capacity of wheel covers and to save transportation space. Moreover, as the snap tabs having base portions and the insert blocks are integrally molded on the wheel cover, manufacturer can save mould expense to lower unit cost. However, when installing the wheel cover to the wheel, the insert block have to be bent first so as to engage with the corresponding base portion of the wheel cover. Not only the alignment is too difficult to conduct engagement but also firm engagement between the engaging portions and the openings can not be achieved. When the car is running on ragged road surface or encountering pits, continual vibration of tires will cause loosening and shaking of the engaging portions and the openings, and even separation of the insert blocks from the base portions so that the wheel cover completely comes off from the wheel.

### SUMMARY OF INVENTION

In order to achieve above object, a plurality of hollow apertures having ornamental design are provided on the wheel cover, and a plurality of snap tab structures for engaging with a metal ring are provided at equal interval on the inboard surface of the wheel cover, each snap tab structure comprising: an base portion disposed in axial direction and formed integrally on the inboard surface of the wheel cover and having an slot provided thereon; and a snap tab body connected with the base portion and integrally formed in radially direction in the space of the hollow aperture; an engaging foot for engaging with the slot is further provided on one side face of the snap tab body and a notch for engagement with the metal ring is formed on the other side face of the engaging foot. When installing the wheel cover to the wheel, the snap tab body is turned to vertical position in such a manner that the engaging foot of the snap tab body engages into the slot formed on the base portion. In this manner, the notches on the snap tab bodies are ready for fitting with the metal ring.

Since the base portion and the snap tab body are integrally formed together, alignment of the base portion and the snap tab body can be ensured so that the engaging foot can be engaged into the slot without deviation so as to form a firm engagement. Hence, there is no loosening and shaking produced at the engagement places of the snap tab bodies and the base portions so that perfect engagement and stable positioning can be provided.

Furthermore, since the snap tab bodies are formed radially in integral manner in the space of the hollow apertures, the bulk volume after stacking of the wheel covers for packing is not influenced by the height of the snap tab bodies, and hence the space occupied by the wheel covers after stacking can be reduced so as to save cost for storage and transportation.

Further, the engaging foot of each snap tab body conforms to the slot in shape, and a hook portion is formed at the top end of the engaging foot. After engaging into the slot, the engaging foot can be locked in place by the hook portion. In this manner, the snap tab body can be engaged firmly on the base portion to ensure that the wheel cover will not come off from the wheel. Furthermore, an abutting portion corresponding to the hook portion is provided on one side face of the engaging foot so that the abutting portion abuts against the periphery wall of the slot, when the hook portion engages on the periphery wall of the base portion, to reinforce the strength of the engaging foot so as to avoid the possible rupture of the engaging foot.

### BRIEF DESCRIPTION OF THE DRAWINGS

FIG. 1 is a perspective view showing the appearance of the first embodiment of the present invention.

FIG. 2 is a partially enlarged perspective view showing the snap tab structure of the first embodiment of the present invention.

FIG. 3 is a sectional view showing the engagement of the snap tab body within the base portion in the first embodiment of the present invention.

FIG. 4 is a schematic view showing the stacked state of the wheel covers of the first embodiment of the present invention.

FIG. 5 is a perspective view showing the appearance of the second embodiment of the present invention.

FIG. 6 is a partially enlarged perspective view showing the snap tab structure of the second embodiment of the present invention.

FIG. 7 is a sectional view showing the snap tab structure of the second embodiment of the present invention.

FIG. 8 is a sectional view showing the engagement of the snap tab body within the base portion in the second embodiment of the present invention.

FIG. 9 is a sectional schematic view showing the engagement of the snap tab body within the base portion in the third embodiment of the present invention.

FIG. 10 is a sectional schematic view showing the engagement of the snap tab body within the base portion in the fourth embodiment of the present invention.

### DETAILED DESCRIPTION OF PREFERRED EMBODIMENTS

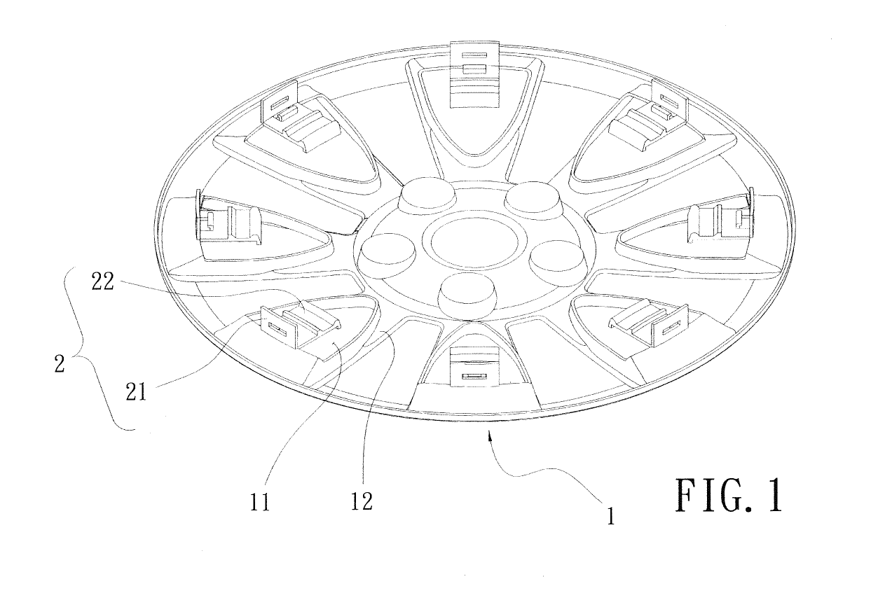

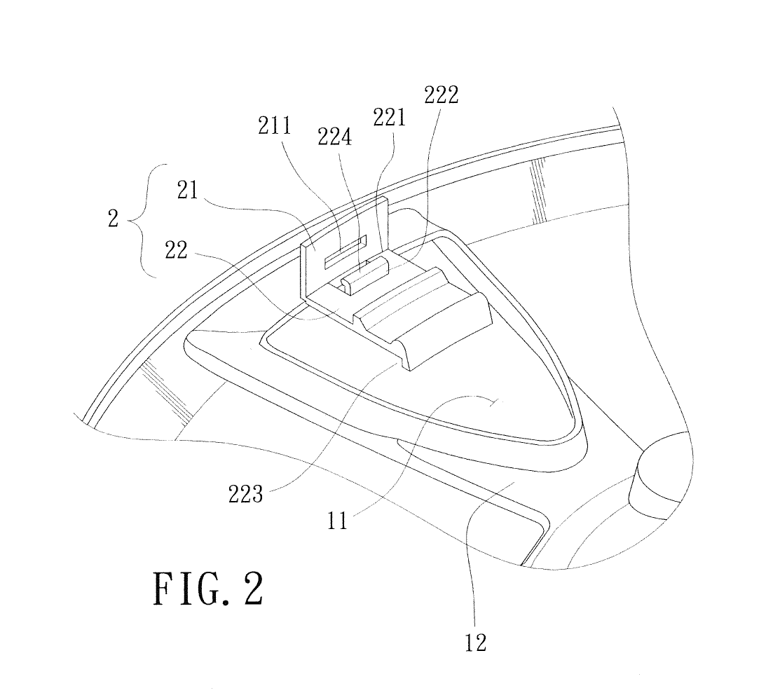

FIGS. 1 to 3 show the first embodiment of the wheel cover tab structure of the present invention. Referring to these figures, the wheel cover (1) has a plurality of hollow apertures (11) having ornamental design, and a plurality of snap tab structures (2) provided at equal interval on the inboard surface of spokes (12) for engaging a metal ring (3). Each snap tab structure (2) comprises:

an base portion (21) disposed axially and formed integrally on the inboard surface of the spoke (12) and having an slot (211) provided thereon, wherein the slot (211) is a rectangular opening; and

a snap tab body (22) connected with the base portion (21) by a connecting portion (221) and integrally formed radially in the space of the hollow aperture from the connecting portion (221), an engaging foot (222) for engaging with the slot (211) being further provided on one side face of the snap tab body (22) and a notch (223) for engaging with the metal ring (3) being formed on the other side face of the engaging foot (222).

Moreover in this embodiment, the engaging foot (222) of each snap tab body (22) conforms to the slot (211) in shape, and a hook portion (224) is formed at the top end of the engaging foot (222). After engaging into the slot (211), the engaging foot (222) can be locked in place by the hook portion (224).

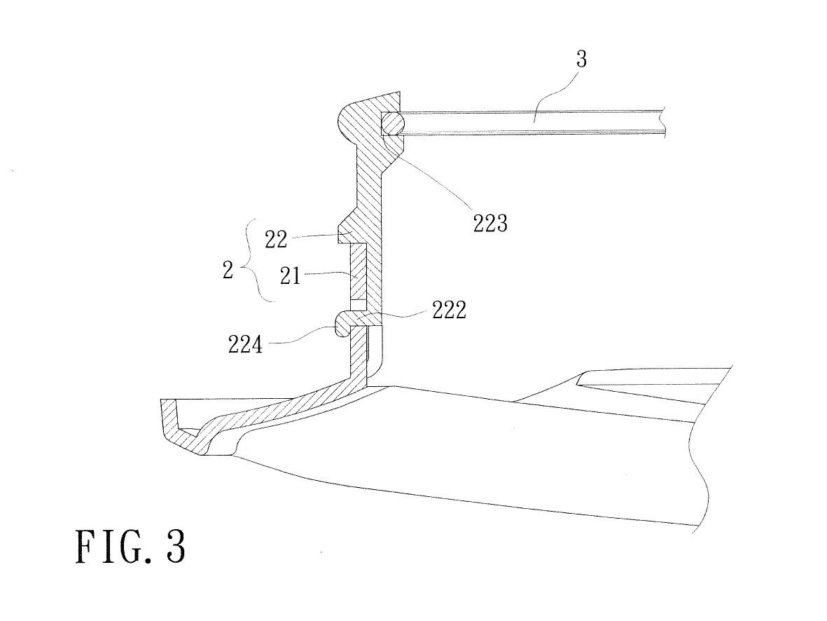

When installing the wheel cover (1) to the wheel, referring to FIG. 3, the snap tab body (22) is turned to vertical position by user in such a manner that the engaging foot (222) of the snap tab body (22) engages within the slot (211) formed on the base portion (21). Since the hook portion (224) is formed at the top end of the engaging foot (222), the engaging foot (222) after entering into the slot (211) can be locked in place by engaging the hook portion (224) onto the periphery wall of the base portion (21). In this manner, the notches (223) on the snap tab bodies (22) are ready for fitting with the metal ring (3).

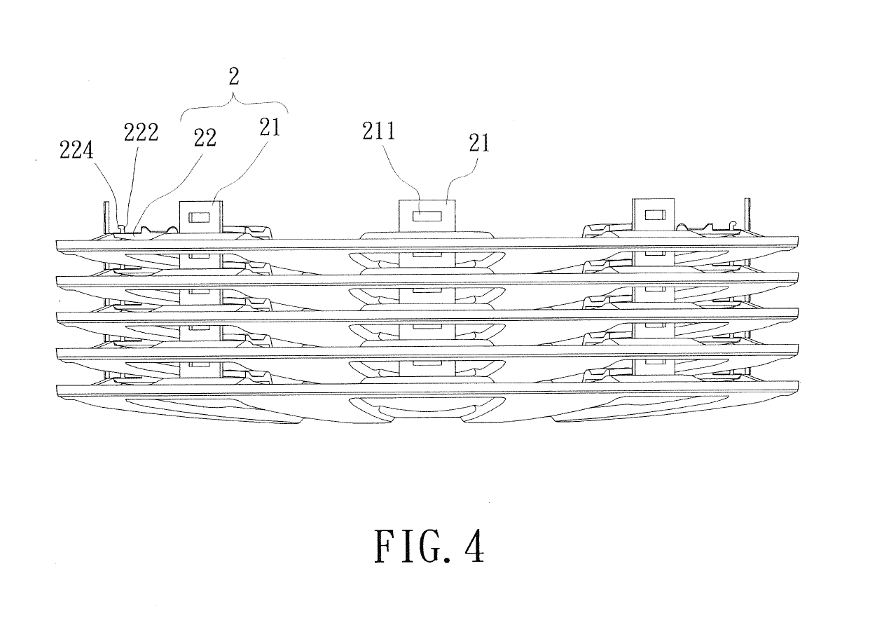

Referring to FIG. 4, when stacking of the wheel covers (1) is conducted for packing, the snap tab bodies (22) have to be turned back directly by user toward the hollow apertures (11) so that the snap tab bodies (22) become parallel to the inboard surface and are received within the space of the hollow apertures (11). Therefore, the height of the wheel cover (1) can be decreased to reduce the space occupied by the wheel cover stack after stacking and thus the cost of storage and transportation can be decreased.

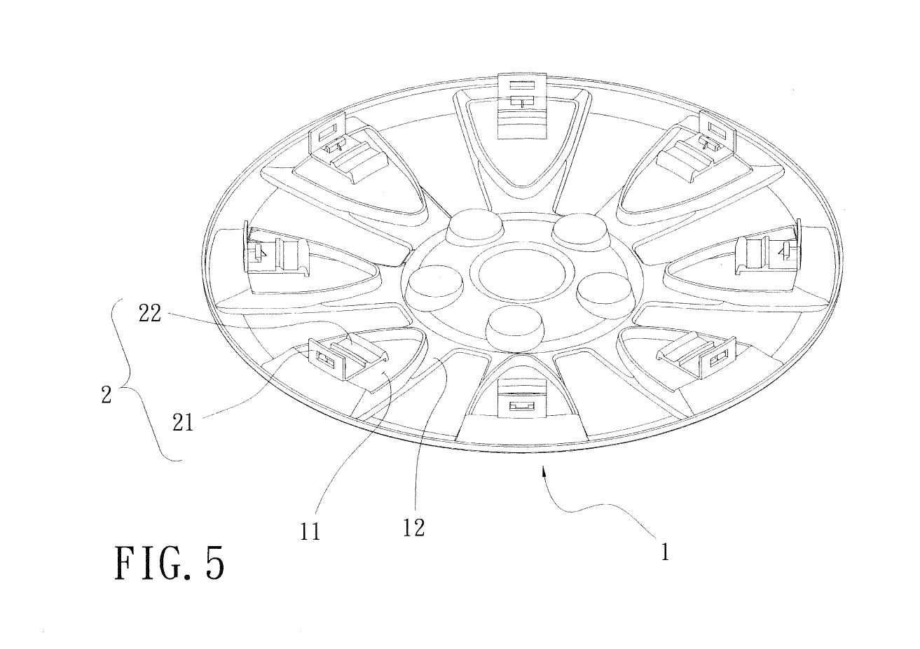

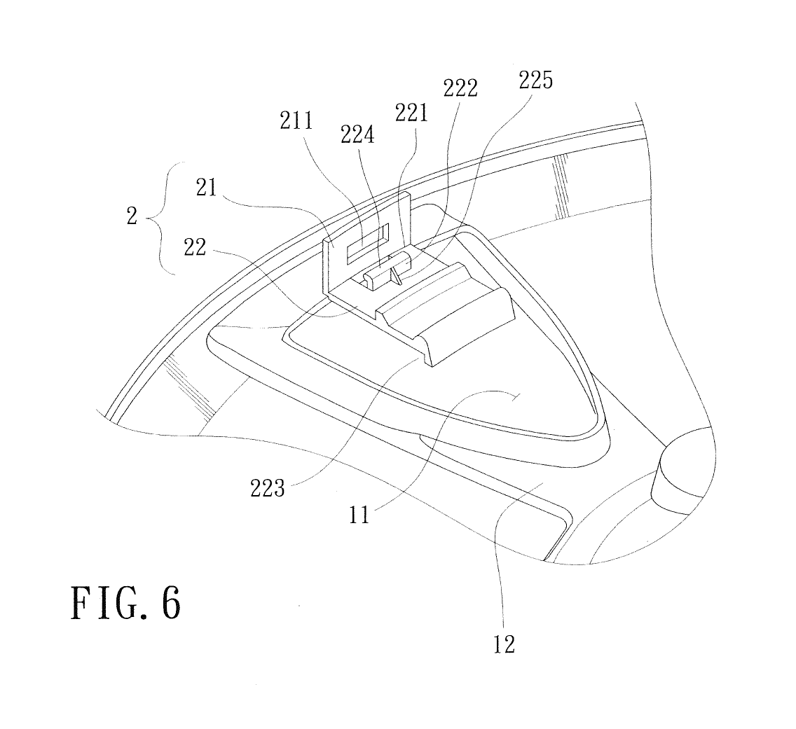

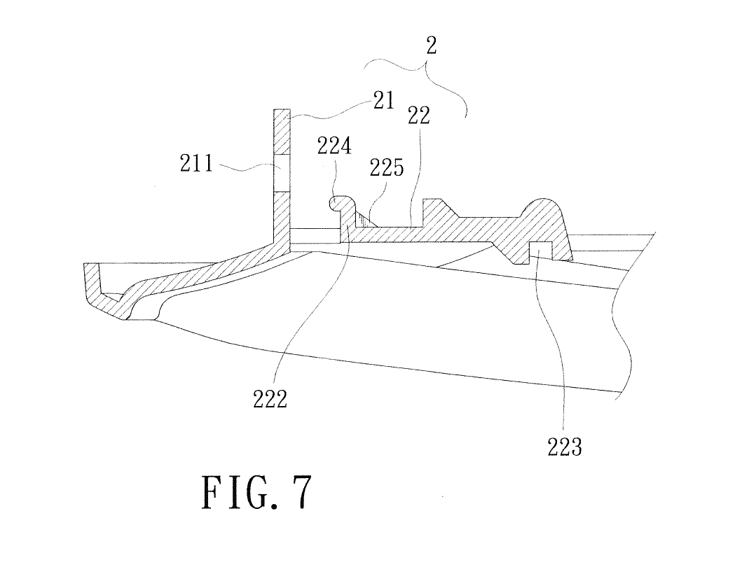

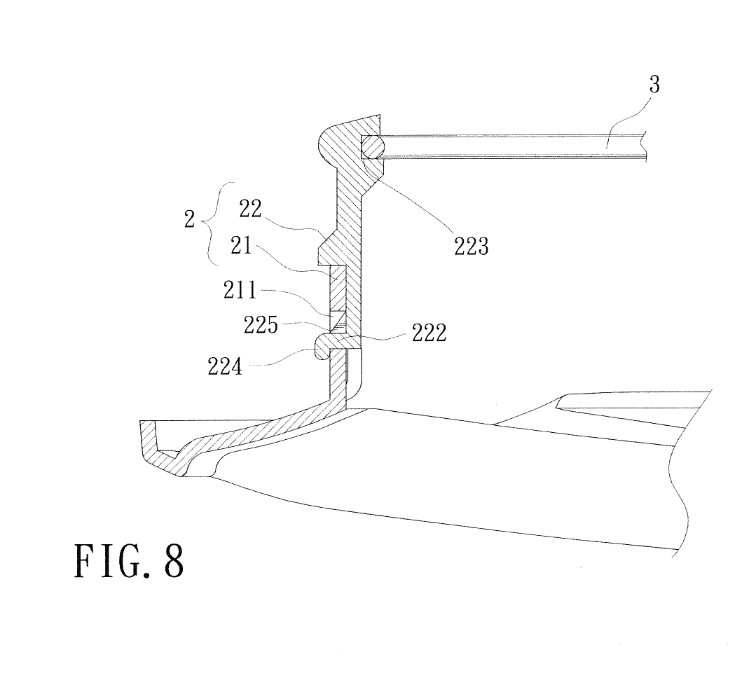

FIGS. 5 and 6 show the second embodiment of the present invention. Referring to these figures, the difference with the first embodiment lies in that an abutting portion (225) corresponding to the hook portion (224) are provided on the inside surface of the engaging foot (222) in such a manner that the abutting portion (225) abuts against the periphery wall of the slot (211), after the engaging foot (222) is inserted into the slot (211). Referring to FIGS. 7 and 8, when the hook portion (224) engages on the periphery wall of the base portion (21), the abutting portion (225) abuts against the peripheral wall of the slot (211) to reinforce the strength of the engaging foot (222) so as to avoid the possible rupture of the engaging foot (222).

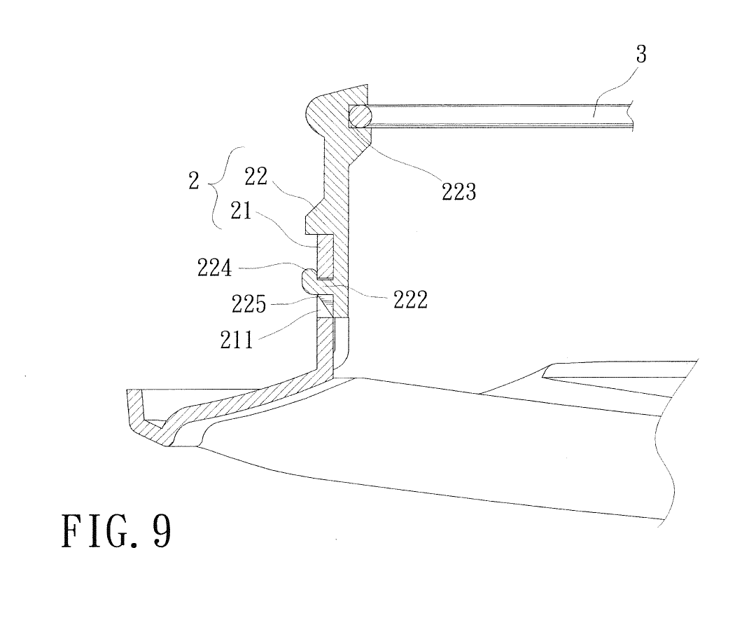

Referring to FIG. 9 showing the third embodiment of the present invention, the difference with the first embodiment lies in that the hook portion (224) at the top end of the engaging foot (222) faces inwardly so as to hook on the top end of the slot (211). Furthermore, an abutting portion (225) corresponding to the hook portion (224) is provided on the inside surface of the engaging foot (222) in such a manner that the abutting portion (225) abuts against the periphery wall of the slot (211), after the engaging foot (222) is inserted into the slot (211).

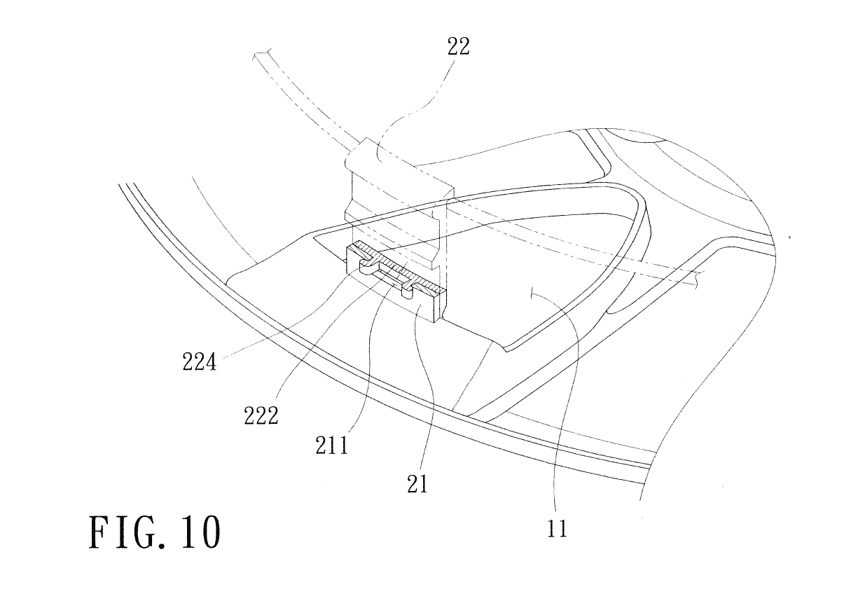

Referring to FIG. 10 showing the fourth embodiment of the present invention, an engaging foot (222) has two hook portions (224) respectively provided at the outside face thereof in such a manner that the two hook portions (224) conduct engagement and fastening after the engaging foot (222) is inserted into the slot (211). Moreover, the two opposite hook portions (224) face outwardly to engage two side ends of the slot (211). Furthermore, abutting portions (not shown) corresponding to the two hook portions (224) are respectively provided on the inside surface of the engaging foots (222) in such a manner that the abutting portions (225) abut against the periphery wall of the slot (211), after the engaging foot (222) is inserted into the slot (211). In this way, assembly time and hence labor hour of the snap tab bodies (22) and the base portion (21) can be reduced, and thus the efficiency of assembling the snap tab bodies (22) to the wheel cover (1) can be increased.

What is claimed is:

1. An improved wheel cover tab structure, wherein the wheel cover has a plurality of hollow apertures having ornamental design, and a plurality of snap tab structures provided at equal interval on the inboard surface of spokes for engaging a metal ring, the wheel cover tab structure comprising:
a base portion disposed in axial direction and formed integrally on the inboard surface of the spoke and having a slot provided thereon; and
a snap tab body connected with the base portion by a connecting portion and integrally formed radially in the space of the hollow aperture from the connecting portion, an engaging foot for engaging with the slot being provided on one side face of the snap tab body and a notch for engagement with the metal ring being formed on the other side face opposite to the engaging foot.

2. The improved wheel cover tab structure as claimed in claim 1, wherein the slot is a rectangular opening.

3. The improved wheel cover tab structure as claimed in claim 1, wherein the engaging foot conforms to the slot in shape, and a hook portion is formed at the top end of the engaging foot, so that the engaging foot after engaging into the slot is locked in place by the hook portion.

4. The improved wheel cover tab structure as claimed in claim 3, wherein the hook portion faces outwardly so as to engage with the bottom end of the slot.

5. The improved wheel cover tab structure as claimed in claim 4, wherein an abutting portion corresponding to the hook portion is provided on the inside face of the engaging foot in such a manner that the abutting portion abuts against the top-end periphery wall of the slot after the engaging foot is inserted into the slot.

6. The improved wheel cover tab structure as claimed in claim 3, wherein the hook portion faces inwardly so as to hook on the top end of the slot.

7. The improved wheel cover tab structure as claimed in claim 6, wherein an abutting portion corresponding to the hook portion is provided on the outside face of the engaging foot in such a manner that the abutting portion abuts against the periphery wall of the slot after the engaging foot is inserted into the slot.

8. The improved wheel cover tab structure as claimed in claim 1, wherein the engaging foot conforms to the slot in shape, and two hook portions are respectively provided at the outside face of the engaging foot in such a manner that the two hook portions conduct engagement for fastening after the engaging foot is inserted into the slot.

9. The improved wheel cover tab structure as claimed in claim 8, wherein the two hook portions are opposite to each other and respectively face outwardly so as to engage both ends of the slot.

10. The improved wheel cover tab structure as claimed in claim 9, wherein the engaging foot conforms to the slot in shape, and abutting portions corresponding respectively to the two hook portions are provided on the inside face of the engaging foot in such a manner that the abutting portions abut against the periphery wall of the slot after the engaging foot is inserted into the slot.
